(19) United States
(12) Patent Application Publication
(10) Pub. No.: US 2014/0327936 A1
(43) Pub. Date: Nov. 6, 2014

(54) Wireless Portable Print Server Devices, Systems, and Methods

(71) Applicants: Kurt Busch, Irvine, CA (US); David Lloyd Wagstaff, Lake Forest, CA (US); Michael Toshiro Lyon, Irvine, CA (US)

(72) Inventors: Kurt Busch, Irvine, CA (US); David Lloyd Wagstaff, Lake Forest, CA (US); Michael Toshiro Lyon, Irvine, CA (US)

(73) Assignee: Lantronix, Inc., Irvine, CA (US)

(21) Appl. No.: 14/335,606

(22) Filed: Jul. 18, 2014

Related U.S. Application Data
(63) Continuation-in-part of application No. 13/315,956, filed on Dec. 9, 2011.
(60) Provisional application No. 61/550,247, filed on Oct. 21, 2011.

(51) Int. Cl. G06F 3/12

(52) U.S. Cl. CPC G06F 3/1292; G06F 3/1236; G06F 3/1203
USPC 358/1.15

(57) ABSTRACT

Wireless portable print server devices, systems, and methods involving a processor and a memory coupled to the processor. The memory including instructions enabling the processor to receive data from a computing device in a format native to the computing device and process the data received from the computing device into a format native to a printing device connected to the print server device. The instructions further enable the processor to provide control signals to the print device and provide the data to the print device in the format native to a printer connected to the print server device.

### CROSS-REFERENCE REFERENCE TO RELATED APPLICATION(S)

This document is a continuation-in-part application which claims priority through, and the benefit of U.S. patent application Ser. No. 13/315,956, filed on Dec. 9, 2011, also entitled “Print Server For A Tablet,” which claims priority to, and the benefit of U.S. Provisional Application Ser. No. 61/550,247, filed on Oct. 21, 2011, also entitled “Print Server For A Tablet,” all of which are herein incorporated by reference in their entirety for all purposes.

### TECHNICAL FIELD

The present disclosure technically relates to printer connectivity. More particularly, the present disclosure technically relates to devices that provide connections between one or more print devices and one or more computing devices. Even more particularly, the present disclosure technically relates to devices, systems, and methods for wirelessly and portably coupling a printer with a processor for facilitating printing of documents and images.

### BACKGROUND

The number of mobile electronic devices in use by people has generally increased in many locations. Further, the computing capability of these mobile electronic devices has tended to increase such that many of the devices have greater capabilities when compared to earlier mobile electronic devices. For example, Apple® Inc., has a line of tablet computers known as the iPad® Apple® Inc., also has the iPhone® as well as other mobile electronic devices. As the computing power of mobile electronic devices from Apple® Inc., as well as other mobile electronic device designers, manufacturers, marketers, etc., has generally increased the capabilities of these devices. For example, many of these devices may be used to print directly from the device to a printer.

Because the computing power, memory, data storage, or other capabilities of a mobile electronic device may still tend to be less than some other computing devices, such as desktop computers, laptop computers, etc., the print capability provided on these mobile electronic devices may be limited in some way. For example, some systems for mobile operating system printing require printers to accept data provided from the mobile electronic device in a predefined format. Such a system can include a method of printing which uses open standards. Accordingly, such a system may not use a plurality of printer-specific drivers for each printer a user would like to print to. Rather, the printer can use a format native to the mobile electronic device. Such a system can provide for printing via WiFi from various mobile electronic devices to a compatible printer.

By using such a standardized system, the mobile electronic device can print without the need for printer-specific drivers. In this way, the complexity of the print routines on the mobile computing device may be decreased and the need for additional memory or data storage for print routines can be avoided. The number of device compatible with mobile wireless device-specific printing formats is generally small, however. Additionally, even as greater and greater numbers of such compatible printers are designed, marketed, and sold, a larger number of incompatible legacy printers may continue to be in use for many years to come.

Accordingly, a need exists for devices, systems, and methods that may allow electronic devices (such as mobile wireless devices) that may have a standardized printing interface, to print to devices that do not communicate using the mobile wireless device standard printing interface.

### SUMMARY

Various embodiments of the devices, systems, and methods described herein facilitate connectivity between electronic devices and print devices, such as printers, plotters, etc. The electronic devices can include mobile wireless devices. In some embodiments, the devices, systems, and methods described herein facilitate printing to print devices that do not communicate using the electronic device's standard print drivers.

An exemplary embodiment of the present disclosure involves devices, systems, and methods for facilitating printing from mobile electronic devices such as an iPad®, iPod® touch, Android®, etc. to a printing device, such as a printer, that does not include a compatible interface by way of a print server that receives the document to be printed using a defined standard over WiFi and without using, e.g., a Windows®, Mac®, or Linux® personal computer.

In an exemplary embodiment of the present disclosure, a print server device comprises: a processor; a memory coupled to the processor, the memory including instructions causing the processor to: receive data from a computing device in a print format that is native to the computing device; process the data received from the computing device into a format native to a printing device connected to the print server device, wherein the data format native to the computing device is different from the format native to a printing device connected to the print server device; provide control signals to the print device; and provide the data to the print device in the format native to the print device connected to the print server device.

In an exemplary embodiment of the present disclosure, a portable wireless print server device, comprising: a memory adapted to store data and at least one set of executable instructions; a processor communicable with the memory, the processor operable by way of the at least one set of executable instructions; the processor adapted to: receive data in a print format native to a computing device; process, by converting, the received data into a format native to a printing device, whereby processed data is providable, the format native to the computing device distinct from the format native to the printing device; transmit at least one control signal to the printing device; and transmit the processed data to the printing device.

In another exemplary embodiment, further comprising at least one feature of a PictBridge feature and a server feature for enhancing receiving, processing, by converting, and transmitting data, such as an image and a document, the at least one feature communicable with at least one of the processor and the memory; wherein the at least one set of executable instructions facilitate communication between the processor and the computing device, the computing device comprising at least one portable electronic device of an iPad® and an iPhone®; wherein the at least one set of executable instructions facilitate communication between the processor and the printing device, the printing device lacking a mobile electronic device-specific print standard interface; and wherein the processor is adapted to receive and transmit at least one file by way of the mobile electronic device-specific print standard over a WiFi connection.

In another exemplary embodiment, wherein the at least one set of executable instructions further comprises instructions for adapting the processor to: discover a printing device on a network with which the processor is coupled, including determining a printer model for the discovered printer; map the printer model to a driver needed; and download the driver based on the mapping from the printer model.

In another exemplary embodiment, wherein the at least one set of executable instructions further comprises instructions for adapting the processor to: receive a mobile electronic device-specific print standard formatted document; format the data for printing using a printer-specific driver; and transmit the data to the printer.

In another exemplary embodiment, wherein the processor is capable of connecting with the printing device by at least one feature of a physical connector, a USB connector, a wireless connection, and a WiFi network.

In another exemplary embodiment, wherein the at least one set of executable instructions further comprises instructions for adapting the processor to perform at least one of discover at least one device by way of an auto-discovery system, capture, and translation.

In another exemplary embodiment, wherein the processor is adapted to transmit the at least one file to the printing device in at least one format of a PDF format, a Post Script format, and a PCL format.

In another exemplary embodiment, wherein the processor is adapted to provide printer driver management.

In another exemplary embodiment, wherein the processor is adapted to provide a connection between a plurality of electronic devices by way of at least one of a USB connection, an Ethernet connection, and a 802.11x standard communication, wherein x denotes any version.

In another exemplary embodiment, wherein the processor is adapted to receive manually input printer information.

In another exemplary embodiment, wherein the processor is adapted to automatically discover a printer and automatically download a driver for the printer.

In an exemplary embodiment of the present disclosure, a method of facilitating printing by way of a portable wireless print server device, the method comprising: receiving data in a print format native to a computing device by a processor; processing, by converting, the received data into a format native to a printing device by way of the processor operable by way of at least one set of executable instructions, whereby converted data is providable, wherein the data format native to the computing device is distinct from the data format native to the printing device; storing the converted data in a memory; transmitting at least one control signal to the printing device by the processor; and transmitting the converted data to the printing device by the processor.

In another exemplary embodiment, further comprising: providing at least one feature of a PictBridge feature and a server feature for enhancing receiving, processing, by converting, and transmitting data, such as an image and a document, the at least one feature communicable with at least one of the processor and the memory; communicating with the computing device; communicating with a printer that does not include a mobile electronic device-specific print native interface; and configuring the print server device to receive document to be printed using the mobile electronic device-specific print standard over WiFi.

In another exemplary embodiment, further comprising downloading a first printer-specific drivers to the print server device that provides the data to the print device in the format native to the print device connected to the print server device; and downloading a second printer-specific driver from a print driver database stored in a cloud of networked computers as needed when a printer not supported by the first printer-specific driver is connected to the print server device the second print-specific driver supporting the printer that is not supported by the first printer-specific driver.

In another exemplary embodiment, further comprising: receiving a mobile electronic device-specific print standard formatted document; formatting the data for printing using a printer-specific driver; and transmitting the data to the printer.

In another exemplary embodiment, further comprising connecting to the printer over a WiFi network.

In another exemplary embodiment, further comprising performing at least one of discovering a device, wherein discovering is performed using an auto discovery system, capturing data, and translating data.

In another exemplary embodiment, further comprising sending a document using at least one format of a PDF format, a Post Script format, and a PCL format.

In another exemplary embodiment, further comprises providing printer driver management.

In another exemplary embodiment, further comprising providing a connection between a plurality of devices by using at least one of a USB connection, an Ethernet connection, and a 802.11x standard communication, wherein x denotes any version.

In another exemplary embodiment, further comprising: discovering a printing device; capturing data; and translating data.

In an exemplary embodiment of the present disclosure, a method of fabricating a portable wireless print server device, comprising: providing a memory adapted to store data and at least one set of executable instructions; providing a processor communicable with the memory, the processor providing comprising providing the processor as operable by way of the at least one set of executable instructions; and providing at least one feature of a PictBridge feature and a server feature for enhancing receiving, processing, by converting, and transmitting data, such as an image and a document, the at least one feature communicable with at least one of the processor and the memory, the processor providing comprising adapting the processor to: receive data in a print format native to a computing device; process, by converting, the data into a format native to a printing device, whereby processed data is providable, the format native to the computing device is distinct from the format native to the printing device; transmit at least one control signal to the printing device; and transmit the processed data to the printing device.

In another exemplary embodiment, the instructions stored in memory enable the print server device to communicate with the computing device, such as a portable device, e.g., an iPad® or iPhone®, wherein the instructions facilitate communication with a printer that does not include a mobile electronic device-specific print standard interface, and wherein the print server device is configured to receive documents to be printed using the mobile electronic device-specific print standard over WiFi.

In another exemplary embodiment, the print server device comprises instructions for enabling the processor to: discover a printer on a network the print server device is connected to, including determining a printer model for the discovered printer; map the printer model to a driver needed; and download the driver based on the mapping from the printer model. In another exemplary embodiment, the instructions enable the print server device to receive a mobile electronic device-specific print standard formatted document, format the data for printing using a printer-specific driver, and transmit the data to the printer. In another exemplary embodiment, the print server device is connected to the printer over a WiFi network. In another exemplary embodiment, the instructions enable the print server device to perform at least one of device discovery, capture, and translation, wherein discovery is performed by way of an auto discovery system.

In another exemplary embodiment, the print server device connects to a printer by sending a document using a PDF format, a Post Script format, or a PCL format. In another exemplary embodiment, the print server device provides printer driver management. In another exemplary embodiment, the print server device provides a connection between a plurality of devices by using a USB connection, an Ethernet connection, an 802.11 communication, or a combination thereof. In another exemplary embodiment, the print server device provides for manually inputting, or manually entering, printer information. In another exemplary embodiment, the print server device automatically discovers a printer and automatically downloads a driver for the printer.

In an exemplary embodiment, a method of facilitating printing from a computing device comprises: receiving data at a print server device from a computing device in a print format that is native to the computing device; converting the data received from the computing device into a format native to a printing device connected to the print server device, the conversion occurring in the print server device, wherein the data format native to the computing device is different from the format native to a printing device connected to the print server device; providing control signals from the print server device to the print device; and providing the data to the print device in the format native to the printing device connected to the print server device.

In another exemplary embodiment, the method comprises: communicating with the computing device: communicating with a printer that does not include a mobile electronic device-specific print native interface; and configuring the print server device to receive a document to be printed using the mobile electronic device-specific print standard over WiFi. In another exemplary embodiment, the method further comprises downloading a first printer-specific drivers to the print server device that provides the data to the print device in the format native to the print device connected to the print server device; and downloading a second printer-specific driver from a print driver database stored in a cloud of networked computers as needed when a printer that is not supported by the first printer-specific driver is connected to the print server device and the second print-specific driver supporting the printer that is not supported by the first printer-specific driver.

In another exemplary embodiment, the method further comprises: receiving a mobile electronic device-specific print standard formatted document; formatting the data for printing using a printer-specific driver, and transmitting the data to the printer. In another exemplary embodiment, the method further comprises: connecting to the printer over a WiFi network. In another exemplary embodiment, the method further comprises: performing device discovery, capture, and translation, wherein discovery is performed using an auto discovery system.

In another exemplary embodiment, the method further comprises: sending a document using the PDF format, the Post Script format, or the PCL format. In another exemplary embodiment, the method further comprises: providing printer driver management. In another exemplary embodiment, the method further comprises: providing a connection between a plurality of devices by using a USB connection, an Ethernet connection, an 802.11 communication, or a combination thereof. In another exemplary embodiment, the method further comprises: discovering a printing device; capturing data from the printing device; and translating the data from the printing device.

In an exemplary embodiment, the print server device includes printer-specific drivers. In an exemplary embodiment, the print server device can download printer-specific drivers. In an exemplary embodiment, the print server device can download printer-specific drivers from the Internet, e.g., using a web site. In an exemplary embodiment, the print server device can receive a mobile device print standard formatted document, format the data for printing using a printer-specific driver, and transmit the data to the printer. In an exemplary embodiment, the print server device is connected to the printer over a WiFi network. In an exemplary embodiment, the print server device is connected to the printer using a universal serial bus connection.

In an exemplary embodiment, a system comprising the print server device, allows a generic printer to appear to be a mobile electronic device-specific print standard printer to a wireless electronic device. In an exemplary embodiment, software is not loaded onto the wireless electronic device. Still another exemplary embodiment involves printing to, for example, a laser printer. In an exemplary embodiment, devices, systems, and methods involve connecting a plurality of devices using a USB connection, an Ethernet connection, an 802.11x communication, or a combination thereof.

Still another exemplary embodiment involves a system and method for performing printer discovery, capture, and translation. Discovery is performed using an auto discovery system or by manually entering printer information. In yet another exemplary embodiment, devices, systems, and methods use Bonjour®, a trade name for an implementation of a group of technologies that includes service discovery, address assignment, and name resolution. Bonjour® may be used to locate printers, computers, services, etc.

Yet another exemplary embodiment involves devices, systems, and methods for connecting a printer by sending a document using the PDF format. Still another exemplary embodiment involves devices, systems, and methods for connecting a printer including performing a PDF to Post Script conversion. Another exemplary embodiment involves devices, systems, and methods for connecting a printer including performing a PDF to PCL conversion. Further, an exemplary embodiment involves devices and systems that are portable or mobile. The devices and systems further comprise printer driver management.

Further, the devices, systems, and methods involve a feature for facilitating direct printing, e.g., a PictBridge feature, wherein images may be printed directly from electronic devices, such as mobile phones and digital cameras to a printer, without having to connect the camera to a computer. The PictBridge may be implemented by way of a USB port and a USB protocol. Printers that are PictBridge-capable typically have a USB type-A receptacle capable of coupling by way of a cable to the USB port of a PictBridge-capable digital device, e.g., a camera (typically a Type Mini-B). The user selects the images on the digital device, e.g., the camera, which the printer retrieves and prints.

Furthermore, a wireless portable print server device comprises: a memory adapted to store data and at least one set of executable instructions; a processor communicable with the memory, the processor operable by way of the at least one set of executable instructions, the processor adapted to: receive data in a print format native to a computing device; process, by converting, the data into a format native to a printing device, whereby processed data is providable, the format native to the computing device is distinct from the format native to the printing device; transmit at least one control signal to the printing device; and transmit the processed data to the printing device, in according to an embodiment of the present disclosure. The wireless portable print server device further comprises at least one feature of a PictBridge feature and a server feature for enhancing receiving, processing, by converting, and transmitting data, such as an image and a document, the at least one feature communicable with at least one of the processor and the memory.

Even further, a method of facilitating printing by way of a wireless portable print server device comprises: receiving data in a print format native to a computing device by a processor; storing the received data and at least one set of executable instructions in a memory; processing, by converting, the received data into a format native to a printing device by way of the processor operable by way of the at least one set of executable instructions, whereby converted data is providable, the data format native to the computing device distinct from the data format native to the printing device; transmitting at least one control signal to the printing device by the processor; and transmitting the converted data to the printing device by the processor, in accordance with an embodiment of the present disclosure. The method of facilitating printing further comprises using at least one feature of a PictBridge feature and a server feature for enhancing receiving, processing, by converting, and transmitting data, such as an image and a document, the at least one feature communicable with at least one of the processor and the memory.

Yet even further, a method of fabricating a portable wireless print server device, comprises: providing a memory adapted to store data and at least one set of executable instructions; providing a processor communicable with the memory, the processor providing comprising providing the processor as operable by way of the at least one set of executable instructions, the processor providing comprising adapting the processor to: receive data in a print format native to a computing device; process, by converting, the received data into a format native to a printing device, whereby processed data is providable, the format native to the computing device distinct from the format native to the printing device; transmit at least one control signal to the printing device; and transmit the processed data to the printing device, in accordance with an embodiment of the present disclosure. The method of fabricating further comprises providing at least one feature of a PictBridge feature and a server feature for enhancing receiving, processing, by converting, and transmitting data, such as an image and a document, the at least one feature communicable with at least one of the processor and the memory.

Additionally, while embodiments of the disclosure are generally described with respect to wireless electronic devices, other computing devices might be connected to a printer using the devices, systems, and methods described herein. In this way, much of the printing overhead might be moved from the computing device to the print server device, thereby saving computer storage space by eliminating the need for multiple print drivers. A single system may be used, e.g., a mobile electronic device-specific print standard for connecting with multiple printers, for example.

### BRIEF DESCRIPTION OF THE DRAWINGS

The above, and other, aspects, features, and advantages of several embodiments of the present disclosure will be more apparent from the following Detailed Description as presented in conjunction with the following several figures of the drawings.

FIG. 1 is a schematic diagram illustrating a print server system having a wireless connection between a mobile electronic device using an open print standard, in accordance with an embodiment of the present disclosure.

FIG. 2 is a schematic diagram illustrating a print server system having a wireless connection between a mobile wireless device and a wireless access point, in accordance with an embodiment of the present disclosure.

FIG. 3 is a flow diagram illustrating a method of using a print server device, such as in a print server system, in accordance with an embodiment of the present disclosure.

FIG. 4 is a flow diagram illustrating a method of using a print server device, such as in a print server system, in accordance with an embodiment of the present disclosure.

FIG. 5 is a schematic diagram illustrating a print server device, in accordance with an embodiment of the present disclosure.

FIG. 6 is a schematic representation, illustrating in a top perspective view, a wireless portable print server device, in accordance with an embodiment of the present disclosure.

FIG. 7 is a schematic representation, illustrating in a side view, a wireless portable print server device, as shown in FIG. 6, in accordance with an embodiment of the present disclosure.

FIG. 8 is a schematic representation, illustrating in an opposing side view, a wireless portable print server device, as shown in FIG. 6, in accordance with an embodiment of the present disclosure.

FIG. 9 is a flow diagram illustrating a method of facilitating printing by way of a wireless portable print server device, in accordance with an embodiment of the present disclosure.

FIG. 10 is a flow diagram illustrating a method of fabricating a wireless portable print server device, in accordance with an embodiment of the present disclosure.

Corresponding reference characters or reference numerals indicate corresponding components throughout the several figures of the Drawing. Elements in the several figures are illustrated for simplicity and clarity and have not necessarily been drawn to scale. For example, the dimensions of some elements in the figures may be emphasized relative to other elements for facilitating understanding of the various presently disclosed embodiments. Also, well-understood elements that are useful or necessary in commercially feasible embodiments are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. That the embodiments of the present disclosure can be practiced, without one or more of the specific details, or with other methods, components, materials, and so forth is contemplated as being encompassed by the present disclosure.

In the following description, numerous specific details are set forth, such as examples of specific voltages, named components, connections, types of circuits, etc., in order to provide a thorough understanding of the present disclosure. It will be apparent, however, to one skilled in the art that the present disclosure may be practiced with or without these specific details. In other instances, well known components or methods have not been described in detail, but, rather, in a block diagram in order to avoid unnecessarily obscuring the present disclosure. Further specific numeric references such as a first device server, a second device server, etc. may be made. However, the specific numeric reference should not be interpreted as a literal sequential order but rather interpreted that the first device server is different than the second device server. Thus, the specific details set forth are merely exemplary. The specific details may be varied from and still be contemplated to be within the spirit and scope of the present disclosure.

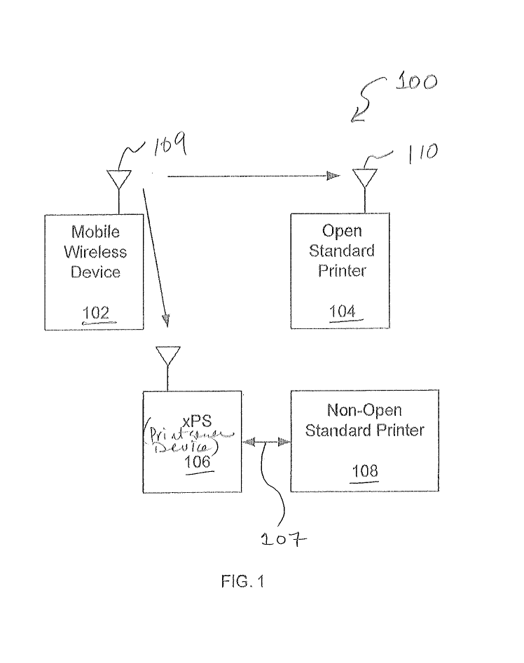

Referring to FIG. 1, this schematic diagram illustrates a print server system 100 having a wireless connection between a mobile electronic device 102 using an open print standard, in accordance with an embodiment of the present disclosure. In the system 100, a wireless connection is made between a portable device, such as a mobile wireless device 102, and an open standard printer 104 as well as between the mobile wireless device 102 and a print server device 106 connected to a non-open standard printer 108. The print server device 106 is connected to a printer 108 that does not necessarily include a printing interface that is mobile wireless device-specific or perhaps includes a mobile wireless device-specific print standard for a type of mobile wireless device other than mobile wireless device 102. In other words, print server device 106 may be used to connect mobile wireless devices 102 to printers that do not include print standards for the specific mobile wireless device 102 used, even when other mobile wireless devices are of a native format for the printer 108. The print server device 106 comprises a physical connector 107, such as a USB connector by example only, for coupling with the printer 108. The mobile wireless device 102 comprises an antenna 109 for communicating with the print sever device 106 and the standard printer 104. The standard printer 104 comprises an antenna 110 for communicating with the mobile wireless device 102

Still referring to FIG. 1, the mobile wireless device 102 may print directly to open standard printer 104. In an example, the open standard printer 104 includes print drivers that can receive wireless signals from the mobile wireless device 102. The printer 104 can interpret these signals 110 and then print the material received. The mobile wireless device 102 comprises a mobile electronic device, such as an iPad®, iPod® touch, Android®, as well as other types of mobile telephone handsets, notebooks, laptops, and other mobile wireless devices that are capable of printing documents to a printer 104. The printer 104 comprises at least one of special hardware, firmware, and software that processes predefined printing instructions such that the mobile wireless device 102 may not need printer-specific print drivers, or may include a simplified set of print drivers. The document to be printed may be transmitted by the mobile wireless device 102 over a network, such as WiFi and any other wireless connection, including wired Ethernet, cellular, satellite, or any other method of networking devices, e.g., through a cable or by other means without connecting through a Windows®, Mac®, Linux®, or other personal computer or server.

Still referring to FIG. 1, the system 100 comprises the mobile wireless device 102 (e.g., iPad®, iPod® touch, Android®, etc.) capable of coupling with a printer 108, such as a printer without a device-specific compatible interface, e.g., at least one of special hardware, firmware, and software that processes predefined printing instructions such that of the mobile wireless device 102. The system 100 can use the print server device 106 to receive a document for printing, print server device 106 using a defined standard over the network, e.g., WiFi, or other wireless connection or a wired connection, e.g., through a cable or by other techniques, thereby overcoming incompatible related art printing devices. The print server device 106 comprises at least one of hardware, firmware, and software that processes predefined printing instructions from the mobile wireless device 102 to facilitate connectivity between the mobile wireless device 102 and print devices, such as the printer 108, that do not communicate using the mobile wireless device's 102 standard printing interface. The system 100 allows a generic printer 108 to appear to be as a mobile electronic device-specific print standard printer (such as printer 104) in relation to the mobile wireless device 102.

Still referring to FIG. 1, in the system 100, the print server device 106 comprises printer-specific drivers. For example, the print server device 106 receives a mobile device print standard formatted document, formats the data for printing using the printer-specific driver, and transmits the data to the printer 108. The printer-specific drivers are preloadable on the device 106 or they may be downloaded by the print server device 106 from, for example, the Internet. The drivers might be updated from time to time or changed as the print server device 106 is decoupled from the printer 108 and coupled with any other printer.

Still referring to FIG. 1, in the system 100, the print server device 106 may be connected to a plurality of devices 108 (e.g., printers) using connections, such as USB, Ethernet, 802.11 (e.g., 802.11b, 802.11n, etc.), and a combination thereof. In another exemplary embodiment, the print server device 106 is connected to the printer 108 or printers using a universal serial bus connection. Other exemplary embodiments include a print server device 106 communicable with the printer 108 over a wireless network such as a WiFi network, a cellular network, a satellite based network. In other embodiments, wired connections, such as wired Ethernet, are useable. The print server device 106 comprises at least one of the foregoing connections these and other connection types.

Still referring to FIG. 1, some embodiments of the devices, systems, and methods describe herein may facilitate printing from a wireless mobile device OS via wired or wireless networks such as wired Ethernet or wireless WiFi, to a non-compatible printers without the use of a Windows®, Mac®, Linux®, or other PC without printer-specific drivers. Some embodiments of the devices, systems, and methods described herein enable any application (web, desktop, mobile) on a mobile wireless device in a network “cloud” to print to any printer without the service provider of the cloud having to create and maintain printing subsystems for all the hardware combinations of client devices and printers, and without the users having to install drivers to the client. Rather, a print server device 106 may be used to connect the printer 108 to the cloud. Applications can print through a web-based, common print dialog (web UI) or an API to the print server device 106.

Still referring to FIG. 1, in the system 100, the device 106 further comprises printer driver management. For example, print server device 106 may also be connected to the Internet, e.g., over a wireless 802.11 network. Periodically, the print server device 106 polls a predetermined web site and determine whether an updated print driver or drivers is/are available. Similarly, if a different printer is connected to the print driver and the print server device 106 lacks a print driver for this type of printer, then downloading a print driver may be necessary that will allow the print server device 106 to print in relation to the newly installed printer.

Still referring to FIG. 1, the printer server device 106 may be connected to one or more printers. These printers may or may not be the same type of printer. Accordingly, the print server device 106 may need to manage one or more types of print drivers. Thus, the print server device 106 comprises enough memory to store at least one print driver. However, some print server devices 106 may be intended to couple with only one printer or only one type of printer at a time, such as for facilitating systems that are more economical, e.g., for consumer purchase.)

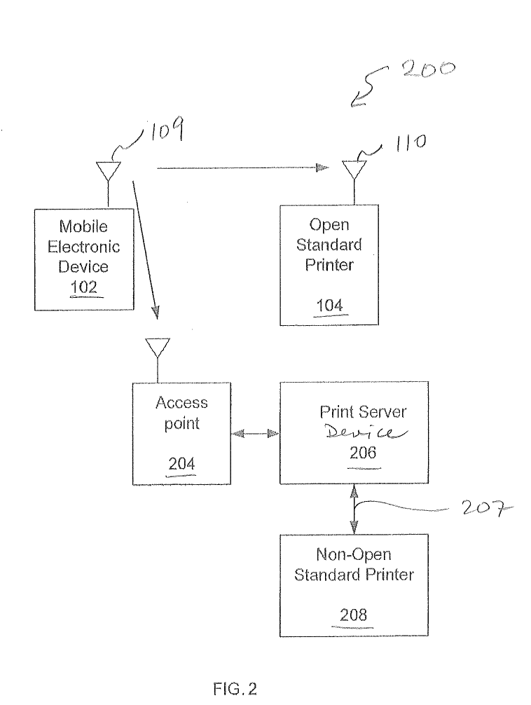

Referring to FIG. 2, this schematic diagram illustrates a print server system 200 having a wireless connection between a mobile wireless device 206 and a wireless access point 204, in accordance with an embodiment of the present disclosure. The wireless access point 204 is connected to the print server device 206 through an example wired network, e.g., Ethernet. In the illustrated example, the print server device 206 is connected to a printer 208, such as a non-mobile electronic device-specific print standard printer, using the Ethernet network connection. The data from the wireless access point 204 is not communicated directly to the printer 208. Rather, data is communicated from the wireless access point 204 to the print server device 206; and the data is then communicated from the print server device 206 to the printer 208. In other embodiments, the connections between the different devices may be wired or wireless. For example, the print server device 206 may include a WiFi network connection to communicate directly with the mobile wireless device 102. The WiFi network connection might also be used to communicate with a non-mobile electronic device-specific print standard WiFi enabled printer. Other wireless networks such as cellular, satellite, etc. might be used. (Alternatively a wired connection between the print server device 206 and the printer 208 might be used. Example wired networks include wired Ethernet.

Still referring to FIG. 2, the print server device 206 may connect to a printer 208 by at least one technique, such as sending a document using the PDF format and performing a PDF to Post Script conversion or a PDF to PCL conversion. The print server device 206 may be small, portable, or mobile, such that The print server device 206 may be easily carried along with the mobile wireless device 102. The print server device 206 of the system 200 provides printer driver management. The printers 208 comprises at least one of a laser printer, an inkjet printer, a dot matrix printer, any other type of printer, as well as any other type of printing device, such as a plotter.

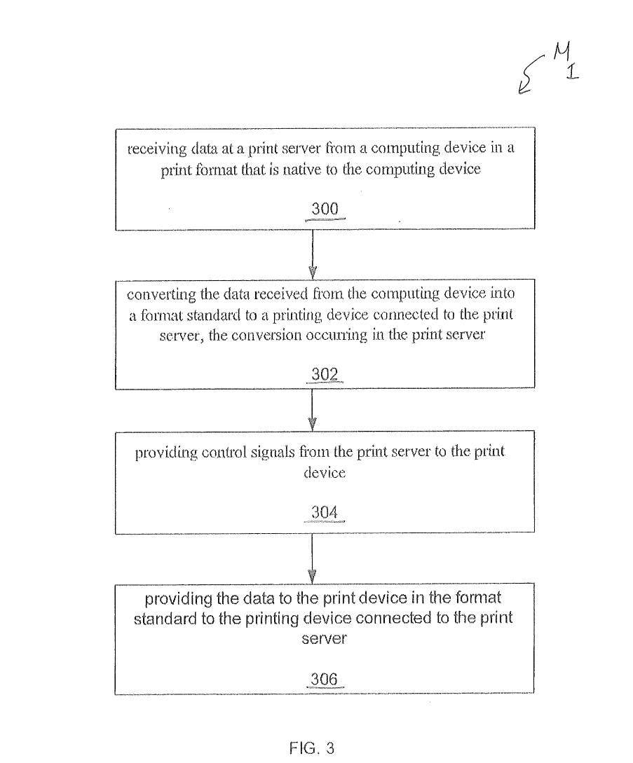

Referring to FIG. 3, this flow diagram illustrates a method M₁ of using a print server device 106, 206, such as in a print server system 100, 200, in accordance with an embodiment of the present disclosure. The method M₁ comprises printing data is received at a print server device from a computing device in a print format that is native to the computing device, as indicated by block 300. The print server device may be similar to print server devices 106 and 206 described with respect to FIGS. 1 and 2. The computing device may be a mobile electronic device (mobile device) such as a mobile wireless device 102, e.g. device. Accordingly, the computing device may include mobile electronic devices, such as an iPad®, iPod touch®, Android®, as well as other types of mobile telephone handsets, notebooks, laptops, and other mobile wireless devices that may print documents to a printer.

Still referring to FIG. 3, the method M₁ further comprises converting the data received from the computing device 102 into a format standard to a printing device 108, 208 connected to the print server device 106, 206, as indicated by block 302. In the illustrated embodiment, the converting step 302 is performable by the print server device 106, 206. The converting step 302 comprises at least one of sending a document using the PDF format, performing a PDF to Post Script conversion, and performing a PDF to PCL conversion. The method M₁ further comprises providing control signals from the print server device 106, 206 to the print device 108, 208, as indicated by block 304. These control signals providing is performable through a wired or wireless interface. For example, the connection between the print server device 106, 206 and the print device 108, 208 may be over an 802.11 standards wireless network.

Still referring to FIG. 3, the method M₁ further comprises providing converted data to the print device 108, 208 in the format native to the print device 108, 208 connected to the print server device, as indicated by block 306. The data may be provided through a wired or wireless interface. Again, for example, the connection between the print server device 106, 206 and the print device 108, 208 may be over an 802.11 standards wireless network. However, steps 304 and 306 are performable by using other wireless standards, using wired connections, or using some combination of wired and wireless standards. For example, some print server devices 106, 206 may be connected to multiple print devices 108, 208. Some print devices 108, 208 may be connected wirelessly, while other print devices 108, 208 are connected using wires. The wired connections may include serial connections, such as USB as well as networked connections such as Ethernet.

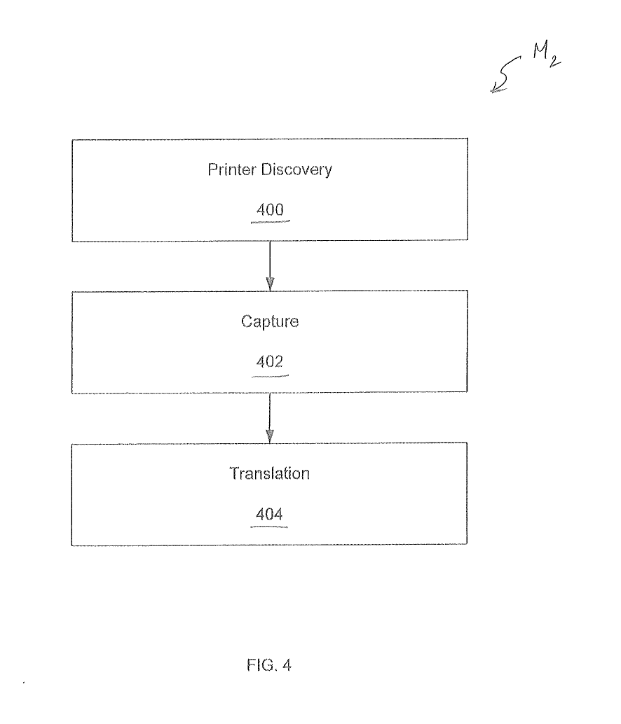

Referring to FIG. 4, this flow diagram illustrates a method M₂ of using a print server device 106, 206, such as in a print server system 100, 200, in accordance with an embodiment of the present disclosure. The method M₂ comprises discovering at least one printer, as indicated by block 400. For example, a mobile electronic device 102 may determine what printers are available for printing. These may include printers that are native format to the mobile electronic device and printers that are not native format. The non-native format printing devices may appear to be native format printing devices to the mobile wireless device. For example, a print server device 106, 206 may cause a non-native printing device to appear to be a native format printing device. Additionally, the method M₂ may include discovery performed using an auto discovery system. For example, discovery in step 400 may use Multicast DNS (mDNS), unicast Domain Name System, Simple Service Discovery Protocol (SSDP) or other discovery protocols.

Still referring to FIG. 4, the method M₂ further comprises capturing data, as indicated by block 402, wherein the material to be captured can be transmitted from the mobile wireless device 102 to the print server device 106, 206. Step 404 comprises translating, e.g., wherein a non-native printing device is enabled for printing the material received from the mobile wireless device. For example, the mobile wireless device may connect to a printer by sending a document using the PDF format. The PDF format might be translated to the Post Script format, PCL format, or other format by the print server device, and then transmitted to the printer for printing.

Referring back to FIGS. 1-4, some embodiments of the devices, systems, and methods described herein may use Bonjour®, which is a trade name for an implementation of a group of technologies that includes service discovery, address assignment, and name resolution. Bonjour® may be used to locate printers, computers, services, etc. Bonjour® is a trade name for Apple® Inc.'s implementation of Zeroconf®, a group of technologies that includes service discovery, address assignment, and name resolution. Zeroconf® is a set of techniques that automatically creates a usable Internet Protocol (IP) network without manual operator intervention or special configuration servers. Zeroconf® can allow devices such as computers and printers to connect to a network automatically. The three basic functions include assignment of numeric network addresses for networked devices, automatic resolution, distribution of computer hostnames, and automatic location of network services, such as printing devices. Bonjour® locates devices, such as printers, other computers, as well as services that those devices offer on a local network using multicast Domain Name System (mDNS) service records. Bonjour® provides a general method to discover services on a local area network.

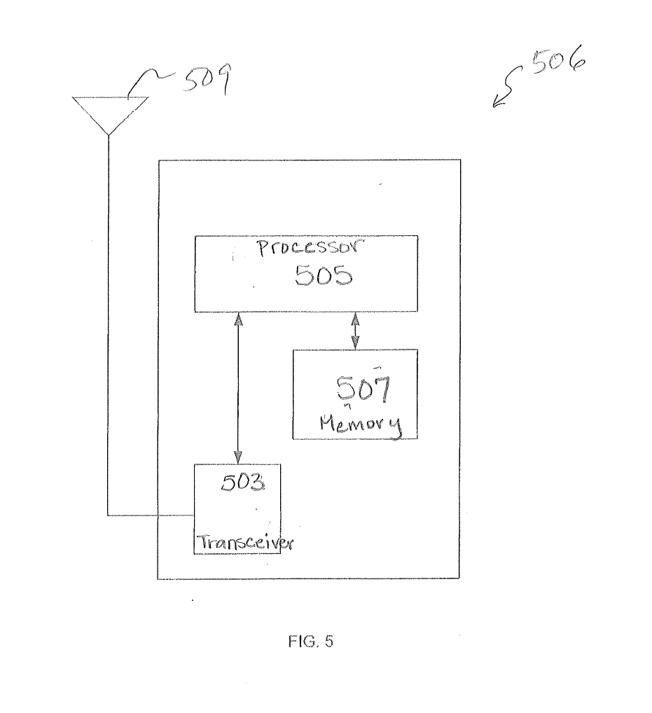

Referring to FIG. 5, this schematic diagram illustrates a print server device 506, in accordance with an embodiment of the present disclosure. The print server device 506 comprises a processor 505. The processor 505 can execute instructions implementing the methods for facilitating printing from a mobile wireless device 102 to a printing device 108, 208 lacking wireless device-specific print drivers. The processor 505 comprises at least one of a microprocessor, microcontroller, digital signal processor, digital logic, programmable digital logic, gate array, field programmable gate array (FPGA), application specific integrated circuit (ASIC), and any other processing device. The processor 505 further comprises at least one of digital circuitry and analog circuitry. Additionally, the processor 505 further comprises at least one of processing device. When multiple processing devices are used, these may include more than one of the same device, multiple types of devices, or combinations of these. The processor 505 may include one or more co-processors.

Still referring to FIG. 5, a memory 507 is coupled to the processor 505. The memory 507 can store instructions and data. These instructions may cause the processor 505 to perform a number of steps. For example, the processor 505 may provide for a system that receives data from a computing device in a print format that is native to the computing device. The system can process the data received from the computing device into a format native to a printing device connected to the print server device. The system may also provide control signals to the print device and provide the data to the print device in the format native to the print device connected to the print server device.

Still referring to FIG. 5, the memory 507 may include semiconductor memory. The semiconductor memory comprises at least one of a volatile memory and a non-volatile memory. The non-volatile memory comprises at least one of a flash memory, ROM, PROM, EPROM, EEPROM, or other types of non-volatile memory, such as FeRAM, CBRAM, PRAM, SONOS, RRAM, Racetrack memory, NRAM and Millipede. The non-volatile memory may be used to store instructions. The volatile memory comprises RAM, such as DRAM or SRAM, as well as other types of RAM, such as Z-RAM, TTRAM, A-RAM, and ETA RAM.

Still referring to FIG. 5, the processor 505 can be connected to a transceiver 503, which can be connected to an antenna. The transceiver 503 may be used to wirelessly connect the print server device 500 to a wireless printer, to the Internet, or to other devices that include wireless connectivity. In an example embodiment the wireless connection may be an 802.11 wireless connection, or other type of wireless connection. A simplified block diagram of an example print server device is shown. Accordingly, to simplify the block diagram, some details are not included. For example, print server device 506 may be powered by standard household power, by battery, or may include circuitry for both. These details are not shown. Additional circuitry may be included in the print server device 506. Further, details within the blocks of the block diagram, such as circuitry implementing a processor have not been included. Many different types of processor 505, memory 507, transceiver 503, etc. may be used. For example, the transceiver 503 may be a circuit for transmitting and receiving electromagnetic signals. In other embodiments, transceiver 503 might be replaced by a separate transmitter circuit, a separate receiver circuit, or both. In some embodiments the print server device 500 may include a first printer-specific driver. For example, the printer-specific driver may be stored in memory 507. The first printer-specific driver can include instructions that cause the processor 505 to provide the data to the print device in the format native to the print device connected to the print server device 506.

Still referring to FIG. 5, additionally, in some embodiments, a print driver database is stored in a cloud of networked computers. These print drivers may be accessed as necessary from “the cloud.” For example, the print server device 506 may include instructions causing the processor 505 to discover a printer on a network to which the print server device 506 is connected. This can include determining a printer model and manufacturer for the discovered printer. The embodiment can map the printer model to a driver needed. Based on the mapping from the printer model the needed driver may be downloading.

Still referring to FIG. 5, the print server device 506 may download a second printer-specific driver from the cloud as needed when a printer that is not supported by the first printer-specific driver is connected to the print server device 506, in accordance with an embodiment of the present disclosure. The second print-specific driver may support the printer that is not supported by the first printer-specific driver. In some embodiments, the memory 507 may store multiple printer-specific drivers. Alternatively, only one driver at a time is stored; as necessary drivers may be overwritten by new drivers. Various schemes may be used to determine when drivers are overwritten, such as first-in first-out (FIFO). In some embodiments the print server device 506 may track usage of particular drivers or track printers that are connected to the print server device 506. The least used driver might be overwritten in some case. Other embodiments of the print server device 506 might overwrite one or more drivers for printers that are no longer connected to the print server device 506 or that have been disconnected from the server for the longest period of time.

Referring to FIG. 6, this schematic representation illustrates, in a top perspective view, a wireless portable print server device 606, comprising: a memory (not shown) adapted to store data and at least one set of executable instructions; a processor (not shown) communicable with the memory, the processor operable by way of the at least one set of executable instructions, the processor adapted to: receive data in a print format native to a computing device, such as a mobile wireless device 602; process, by converting, the received data into a format native to a printing device, such as a non-open standard printer 608, whereby processed data is providable, the format native to the computing device, e.g., the mobile wireless device 602, is distinct from the format native to the printing device, e.g., the non-open standard printer 608; transmit at least one control signal to the printing device, e.g., the non-open standard printer 608; and transmit the processed data to the printing device, e.g., the non-open standard printer 608, in accordance with an embodiment of the present disclosure. The wireless portable print server device 606 further comprises at least one feature of a PictBridge feature (not shown) and a server feature (not shown) for enhancing receiving, processing, by converting, and transmitting data, such as an image and a document, the at least one feature communicable with at least one of the processor and the memory. The wireless portable print server device 606 further comprises at least one of at least one functional button 610, at least one slot 620, at least one USB connector 630, and at least one indicator light 640.

Still referring to FIG. 6, the wireless portable print server device 606 may comprise a small size, e.g., in a range approximately that of a thumb-drive sized device. The wireless portable print server device 606 is interface-powerable, such as USB powerable, and capable of electronically coupling with a PictBridge port, e.g., via a plug, of a so-supported printer, such as the non-open standard printer 608. The wireless portable print server device 606 is capable of connecting with either a WiFi infrastructure network (infrastructure client mode) and a SoftAP (Soft App mode), or even both (modes), simultaneously. So connected, the wireless portable print server device 606 facilitates printing as at least one of a Bonjour® advertised printer and an AirPrint® advertised printer, whereby print jobs are convertible to a PictBridge control and a PictBridge print protocol. The wireless portable print server device 606 further comprises a web server (not shown) for uploading images from any connected tablet (not shown) or PC (not shown) and for facilitating printing via the PictBridge feature (not shown) using a virtual digital camera interface (not shown).

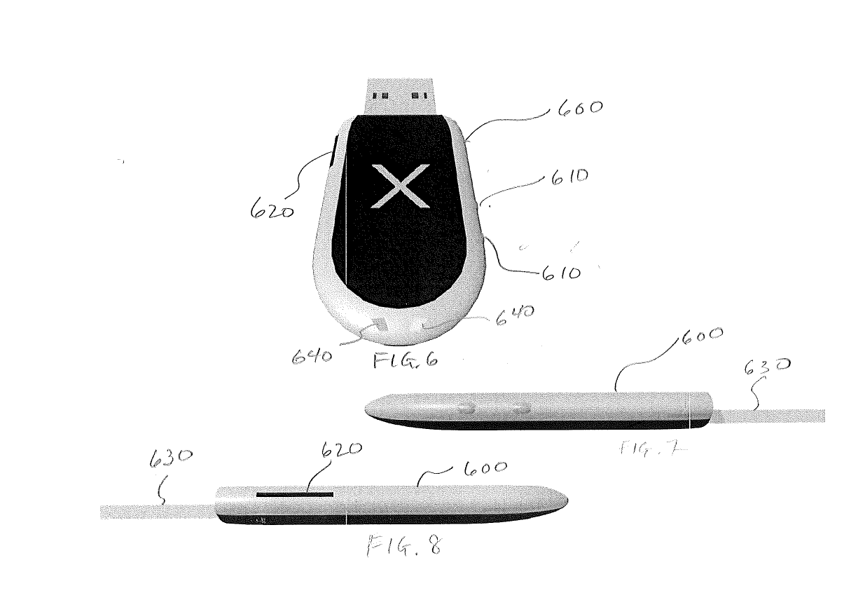

Still referring to FIG. 6 and ahead to FIGS. 7 and 8, the wireless portable print server device 606 comprises various hardware features, as briefly described above and as described in more detail as follows. The wireless portable print server device 606 is compliant with 802.11x WiFi standards. The at least one indicator light 640 comprises at least one of: at least one primary light-emitting diode (LED) for indicating a status, such as a connectivity status, and at least one secondary LEDs for indicating a corresponding plurality of designable parameters (FIG. 6). The at least one functional button 610 comprises at least one of: at least one WiFi-protected setup (WPS) button and at least one multi-function button, such as for resetting, factory-restoring, and request safe disconnection of the device 606 (FIG. 7). The at least one slot 620 comprises at least one of: at least one micro-USB slot, at least one micro-SD slot, and at least one micro-SIM slot (FIG. 8). The wireless portable print server device 606 is further adapted to: buffer jobs for printing and store uploaded imaged from web interface.

Still referring to FIG. 6, the wireless portable print server device 606 comprises various software features, as briefly described above and in more detail described as follows. The wireless portable print server device 606 comprises at least one software feature of: an AirPrint® feature, the AirPrint® feature capable of advertising as a generic photo printer, having scripted default actions for controlling a PictBridge printer, and having configurable settings for controlling the PictBridge printer; a built-in web interface; a dynamic host configuration protocol (DHCP) server on a software enabled access point (SoftAP) interface, such as a fixed class C address pool and being independent of the infrastructure interface; a virtual camera interface adapted to mimic the interface on a PictBridge capable camera, upload images from a tablet or a PC, and review and select images to print; a local authentication capability, such as an option requiring a username and a password for printing and a default being no authentication; a remote authentication, such as an option using an infrastructure interface for authenticating to a lightweight directory access protocol/active directory (LDAP/AD) and a group support to limit for printing to members of a specific group; a logging feature, such as an authentication logging, a print job logging, a redirect logging (RSS, SMS, E-mail, Syslog, SNMP, FTP as CSV file, NFS as CSV or text file, and socket to listener, e.g., data sent as RAW data and data sent as CSV); and a mass storage and auto-run, such as plugging the print server device 606 into a PC for various configurations, e.g., presenting as a USB mass storage device, auto-running an HTML-based configuration interface, an interface connecting back to the print server device 606, configuring infrastructure settings, configuring authentication and authorization, creating a custom template for PictBridge function, and mass storage for uploading photos to a Micro-SD card, such as photos retrievable over a wireless connection, e.g., via web interface or via file sharing.

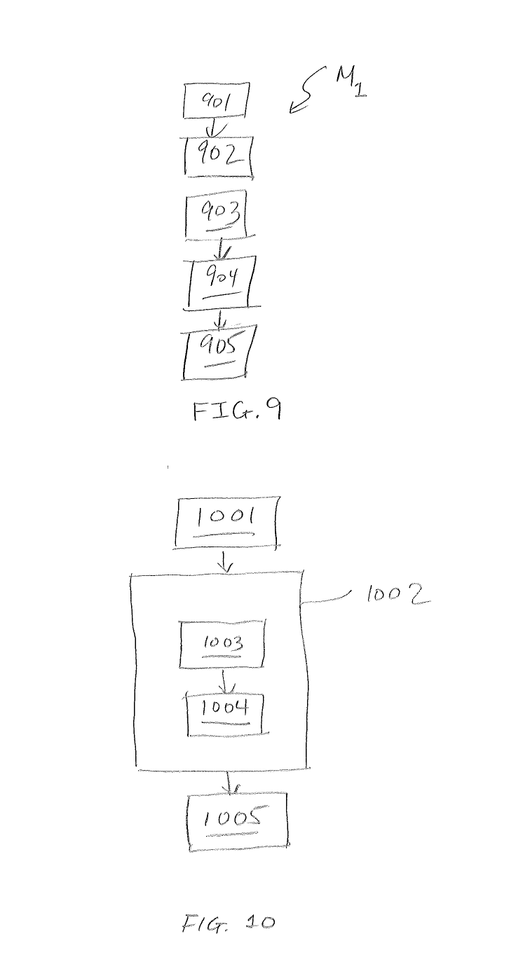

Referring to FIG. 9, this flowchart illustrates a method M₃ of facilitating printing by way of a wireless portable print server device 606, the method M₃ comprising: receiving data in a print format native to a computing device by a processor, as indicated by block 901; processing, by converting, the data received into a format native to a printing device by way of the processor, whereby converted data is providable, wherein the data format native to the computing device is distinct from the data format native to the printing device, as indicated by block 902; transmitting at least one control signal to the printing device by the processor, as indicated by block 903; and transmitting the converted data to the printing device by the processor, as indicated by block 904, in accordance with an embodiment of the present disclosure. The method of facilitating printing further comprises using a PictBridge feature for enhancing receiving, processing, by converting, and transmitting data, such as an image and a document, the at least one feature communicable with at least one of the processor and the memory, as indicated by block 905.

Still referring to FIG. 9, by example only, possible scenarios may involve a mobile iPad® user requiring printing, wherein the user readily plugs the device 606 into a PictBridge printer, connects to the SoftAP, prints the job, requests disconnect, and thereby disconnects; a POS or a service technician desiring printing via a printer in a mobile environment, wherein readily plugs the device 606 into a mobile printer having a PictBridge, wherein configuration is unnecessary for AirPrint®, and wherein other tablets can upload images and print; hotel management desiring to provide printing in a conference room, a business center, or a lobby, wherein a guest sets-up the device 606 on a printer, creates AD user account, and prints, wherein the print job is logged and sent via an IP socket to a PC running WinWedge®, whereby the job log is parsed and converted to any DDE format; in a classroom situation, an instructor connects the device 606 to printer, wherein students can print via an infrastructure connection, or, if the desire is to limit access, wherein students are required to connecting with the SoftAP®, thereby limiting access to only that particular printer.

Referring to FIG. 10, this flowchart illustrates a method M₄ of fabricating a portable wireless print server device 606, the method M₄ comprising: providing a memory adapted to store at least one set of executable instructions, as indicated by block 1001; providing a processor communicable with the memory, as indicated by block 1002, the processor providing comprising providing the processor as operable by way of the at least one set of executable instructions, as indicated by block 1003, the processor providing comprising adapting the processor to: receive data in a print format native to a computing device; process, by converting, the received data into a format native to a printing device, whereby processed data is providable, the format native to the computing device is distinct from the format native to the printing device; transmit at least one control signal to the printing device; and transmit the processed data to the printing device, indicated by block 1004, in accordance with an embodiment of the present disclosure. The method of fabricating further comprises providing a PictBridge feature for enhancing receiving, processing, by converting, and transmitting data, such as an image and a document, the at least one feature communicable with at least one of the processor and the memory, as indicated by block 1005.

Referring back to FIGS. 6-10, the wireless portable print server device 606 is adapted to facilitate printing an image from the cloud, such as via a cellular cloud print feature, in accordance with an alternative embodiment of the present disclosure. The wireless portable print server device 606 comprises a small, USB-powered, thumb-drive sized device that plugs into a PictBridge port on a so-supported printer and provides connectivity to a cellular data service, such as cellular Google® cloud print. So connected, the device 606 adapts the printer as a cloud printer. Once configured, e.g., with a Google® account, the device 606 appears as a printer on the account's “Cloud Print” page. Jobs are then convertible to a PictBridge control and print protocol. Once configured, whenever the device 606 is connected to the PictBridge port on a so-supported printer, the device 606 connects to the cellular data network and logs into the Google® Cloud. Any queued print jobs are downloaded and converted to PictBridge print jobs.

Still referring back to FIGS. 6-10, the wireless portable print server device 606 alternatively comprises various hardware features, as briefly described above and as described in more detail as follows. The wireless portable print server device 606 is compliant with cellular data connection standards, such as 4GLTE, 3G fallback (HSPA+ and/or EVDO), and possible WiFi edition with WiFi as the primary connection and cellular as a fallback connection. The device 606 comprises at least one indicator light 640, the at least one indicator light 640 comprising at least one of: at least one primary light-emitting diode (LED) for indicating a status, such as a connectivity status, and at least one secondary LEDs for indicating a corresponding plurality of designable parameters (FIG. 6). The device 606 comprises at least one functional button 610, the at least one functional button 610 comprising at least one of: at least one WiFi-protected setup (WPS) button if the unit supports WiFi and at least one multi-function button, such as for resetting, factory-restoring, and request safe disconnection of the device 606 (FIG. 7). The device 606 comprises at least one slot 620, the at least one slot 620 comprising at least one of: at least one micro-SIM slot (FIG. 8) and at least one Micro-SD slot for uploading pictures and printing thereof or for inserting a card already having pictures and print thereof.

Still referring back to FIGS. 6-10, the wireless portable print server device 606 alternatively comprises various software features, as briefly described above and in more detail described as follows. The wireless portable print server device 606 comprises at least one software feature of: a USB auto-run configuration adapted to: enumerate as a mass storage device, run a universal (possibly HTML) configuration utility, configure settings to control a PictBridge printer, to provide firmware updates, to setup Google® account information, and to provide WiFi settings if so equipped.

Referring back to FIG. 9, by example only, the method M₁ may involve possible scenarios in using the alternative embodiment of the device 606 may involve a mobile user requiring printing, wherein the user can plug a device 606, comprising a Cellular Google® Cloud PictBridge feature, into a PictBridge printer, whereby upon booting, the device 606 connects to the cellular network, wherein the user has already submitted a print job, wherein the print job is retrievable by the print server device 606 as soon as the print server device 606 connects to the Google® Cloud, or the user can send the job at that moment. Once complete, the user removes the print server device 606 from the printer. Another possible scenario involves a POS or a service technician desiring to print to a printer in a mobile environment, wherein the printer comprises a mobile printer, e.g., disposed in a service vehicle, and wherein the service technician has a smart-phone or a tablet with an Internet connection. The technician is now able to print invoices, receipts, and work orders in the service vehicle without being in wireless range of the printer. Additionally, items, such as work orders, can be printed to PictBridge capable printers at other locations through another print server device 606 or a GCP model xPrintServer.

Referring back to FIG. 10, the method M₂ of fabricating a portable wireless print server device 606 alternatively comprises: providing a memory adapted to store at least one set of executable instructions, as indicated by block 1001; providing a processor communicable with the memory, as indicated by block 1002, the processor providing comprising providing the processor as operable by way of the at least one set of executable instructions, as indicated by block 1003, the processor providing comprising adapting the processor to: receive data in a print format native to a cloud environment, e.g., the Google® Cloud; process, by converting, the data into a format native to a printing device, whereby processed data is providable, the format native to the computing device is distinct from the format native to the printing device; and transmit at least one control signal to the printing device; and transmit the processed data to the printing device, as indicated by block 1004, in accordance with an embodiment of the present disclosure. The method of fabricating further comprises providing a PictBridge feature for enhancing at least one step of receiving, processing, by converting, and transmitting an image, the image originating from a cloud environment, the PictBridge feature in electronic communication with at least one of the processor and the memory, as indicated by block 1005.

Referring back to FIGS. 6-10, the print server device 606 is readily plugged into a PictBridge port of a printing device and behaves in a manner that is consistent with a digital camera for transmitting images to the printing device. The print server device 606 also has at least the benefits of being capable of connecting to networks, capable of acting as a soft access point, powerable by an interface, pocket-sized, being, of syncing with an iPad® and Air Print®. The print server device 606 can further sync with other devices, e.g., tablets, PCs, or cellular phones, whereby opening a web page, uploading a photo, and providing a virtual digital camera interface are facilitated. Over a wireless connection, the print server device 606, acting as a virtual digital camera, may be run on a tablet, upload pictures, moved to a printer, print the images, be readily unplugged and sprinted away in the pocket.

Still referring back to FIGS. 6-10, the print server device 606 overcomes the obstacle of a proprietary print language, e.g., that of GDI printers, Windows® printers, or host-based printers by at least using a PictBridge, wherein the device 606 is at least substantially ubiquitous in relation to any PictBridge printer, regardless of its proprietary print language. Another benefit of the device 606 is that the need for a plurality of drivers is eliminated as any necessary drivers would be preloaded therein. The virtual digital camera capability of the device 606 facilitates printing images from non-IOS tables, such as Windows® Tables and any image for which a web page is connectable and openable.

Still referring back to FIGS. 6-10, the print server device 606 is capable of enterprise-based authentication, offloading print logs using a number of different transport mechanisms, e.g., for hospitality and visiting office applications. The images comprise pictures, emails, documents, and any other file capable of sending as a bit map picture or as a .jpeg file which is compatible with digital camera use as well as any other file capable of sending or being converted, or even auto-converted, via iOS or iPhone® OS. The print server device 606 further comprises at least one optional conversion filter for facilitating uploading any file type, e.g., a bit map. a .jpeg file, a .pdf file, and the like, and further converting the file into a format friendly with any given printer. Alternatively, the print server device 606 is adapted to handle a full set of documentation, such as stored on a CD or on a USB-based product having sufficient flash memory.

Additionally, the print server device 606 is configured for immediate use, e.g., from the box or packaging, as the print server device 606 comprises a default user name and a default password, whereby lengthy installation is eliminated and authentication with an electronic device, such as a PC, is facilitated, whereby, in the absence of installing any programs on the electronic device, such as the PC, opening a web interface is still possible, and whereby uploading files, e.g., picture files, to the electronic device is facilitated. The print server device 606 is also adapted to facilitate printing from at least one of Windows®, e.g., via a Bonjour® Print Service, and Mac®, for at least that the device 606 is capable of at least one of physically interfacing with at least one printer and finding a printer, e.g., by advertising a name of a printer or a generic printer. The user can readily hit “print/scan,” click on the “plus” sign to add a printer, etc. Also, the device 606 further comprises a multi-level authentication feature, wherein a wireless connection would have an authentication that is distinct from that of a web interface. Alternatively, the electronic device, such as a printer, to which a user desires to connect the device 606 may send a signal back to the device 606, wherein the device 606 authenticates.

In the related art, office grade printing equipment, such as large copiers by Toshiba® or Ricoh®, do not have a standard for security suites. For interfacing with such products, the print server device 606 is further adapted to capture raw data, parse the raw data, and transmit the raw data using at least one program, such as Winsock, whereby IP sockets are incorporated into custom software, or WinWedge® and TCPWedge® from TalTech®, whereby the raw data is transformed into DDE information, and whereby distributing data universally to any DDE-compliant application becomes possible. The print server device 606 provides all the transport mechanisms such that a user can handle logging information into his/her electronic system, accounting system, security system, and the like.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed:

1. A portable wireless print server device, comprising:
a memory adapted to store data and at least one set of executable instructions;
a processor communicable with the memory, the processor operable by way of the at least one set of executable instructions;
the processor adapted to:
receive data in a print format native to a computing device;
process, by converting, the received data into a format native to a printing device, whereby processed data is providable, the format native to the computing device distinct from the format native to the printing device;
transmit at least one control signal to the printing device; and
transmit the processed data to the printing device.

2. The print server device of claim 1, further comprising at least one feature of a PictBridge feature and a server feature for enhancing receiving, processing, by converting, and transmitting data, such as an image and a document, the at least one feature communicable with at least one of the processor and the memory;
wherein the at least one set of executable instructions facilitate communication between the processor and the computing device, the computing device comprising at least one portable electronic device of an iPad® and an iPhone®;
wherein the at least one set of executable instructions facilitate communication between the processor and the printing device, the printing device lacking a mobile electronic device-specific print standard interface; and
wherein the processor is adapted to receive and transmit at least one file by way of the mobile electronic device-specific print standard over a WiFi connection.

3. The print server device of claim 1, wherein the at least one set of executable instructions further comprises instructions for adapting the processor to:
discover a printing device on a network with which the processor is coupled, including determining a printer model for the discovered printer;
map the printer model to a driver needed; and
download the driver based on the mapping from the printer model.

4. The print server device of claim 1, wherein the at least one set of executable instructions further comprises instructions for adapting the processor to:
receive a mobile electronic device-specific print standard formatted document;
format the data for printing using a printer-specific driver; and
transmit the data to the printer.

5. The print server device of claim 1, wherein the processor is capable of connecting with the printing device by at least one feature of a physical connector, a USB connector, a wireless connection, and a WiFi network.

6. The print server device of claim 1, wherein the at least one set of executable instructions further comprises instructions for adapting the processor to perform at least one of discover at least one device by way of an auto-discovery system, capture, and translation.

7. The print server device of claim 2, wherein the processor is adapted to transmit the at least one file to the printing device in at least one format of a PDF format, a Post Script format, and a PCL format.

8. The print server device of claim 1, wherein the processor is adapted to provide printer driver management.

9. The print server device of claim 1, wherein the processor is adapted to provide a connection between a plurality of electronic devices by way of at least one of a USB connection, an Ethernet connection, and a 802.11x standard communication, wherein x denotes any version.

10. The print server device of claim 1, wherein the processor is adapted to receive manually input printer information.

11. The print server device of claim 1, wherein the processor is adapted to automatically discover a printer and automatically download a driver for the printer.

12. A method of facilitating printing by way of a portable wireless print server device, the method comprising:
receiving data in a print format native to a computing device by a processor;
processing, by converting, the received data into a format native to a printing device by way of the processor operable by way of at least one set of executable instructions, whereby converted data is providable, wherein the data format native to the computing device is distinct from the data format native to the printing device;
storing the converted data in a memory;
transmitting at least one control signal to the printing device by the processor; and
transmitting the converted data to the printing device by the processor.

13. The method recited in claim 12, further comprising:
providing at least one feature of a PictBridge feature and a server feature for enhancing receiving, processing, by converting, and transmitting data, such as an image and a document, the at least one feature communicable with at least one of the processor and the memory;
communicating with the computing device;
communicating with a printer that does not include a mobile electronic device-specific print native interface; and
configuring the print server device to receive document to be printed using the mobile electronic device-specific print standard over WiFi.

14. The method recited in claim 12, further comprising
downloading a first printer-specific drivers to the print server device that provides the data to the print device in the format native to the print device connected to the print server device; and
downloading a second printer-specific driver from a print driver database stored in a cloud of networked computers as needed when a printer not supported by the first printer-specific driver is connected to the print server device the second print-specific driver supporting the printer that is not supported by the first printer-specific driver.

15. The method of claim 12, further comprising:
receiving a mobile electronic device-specific print standard formatted document;
formatting the data for printing using a printer-specific driver; and
transmitting the data to the printer.

16. The method of claim 12, further comprising connecting to the printer over a WiFi network.

17. The method of claim 12, further comprising performing at least one of discovering a device, wherein discovering is performed using an auto discovery system, capturing data, and translating data.

18. The method of claim 12, further comprising sending a document using at least one format of a PDF format, a Post Script format, and a PCL format.

19. The method of claim 12, further comprises providing printer driver management.

20. The method of claim 12, further comprising providing a connection between a plurality of devices by using at least one of a USB connection, an Ethernet connection, and a 802.11x standard communication, wherein x denotes any version.

21. The method of claim 12, further comprising:
discovering a printing device;
capturing data; and
translating data.

22. A method of fabricating a portable wireless print server device, comprising:
providing a memory adapted to store data and at least one set of executable instructions;
providing a processor communicable with the memory, the processor providing comprising providing the processor as operable by way of the at least one set of executable instructions; and
providing at least one feature of a PictBridge feature and a server feature for enhancing receiving, processing, by converting, and transmitting data, such as an image and a document, the at least one feature communicable with at least one of the processor and the memory,
the processor providing comprising adapting the processor to:
receive data in a print format native to a computing device;
process, by converting, the data into a format native to a printing device, whereby processed data is providable, the format native to the computing device is distinct from the format native to the printing device;
transmit at least one control signal to the printing device; and
transmit the processed data to the printing device.
